(19) United States
(12) Patent Application Publication
(10) Pub. No.: US 2006/0012625 A1
(43) Pub. Date: Jan. 19, 2006

(54) PRINT SYSTEM CAPABLE OF DETECTING AN ABNORAML PRINT CONDITION

(76) Inventor: Yao-Te Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/908,703

(22) Filed: May 23, 2005

(30) Foreign Application Priority Data
Jul. 16, 2004 (TW) 093121349

(51) Int. Cl. B41J 29/393

(52) U.S. Cl. 347/19

(57) ABSTRACT

A print system includes a print module for printing an image, a motor module for driving the print module, a detecting module for detecting a physical parameter of a component of the print system, and a control module electrically connected to the detection module for controlling the print system, generating a change rate of the physical parameter according to physical parameters detected by the detecting module, and adjusting the operation of the print system according to the change rate of the physical parameter.

### BACKGROUND OF THE INVENTION

1. Field of the Invention

The invention relates to a print system capable of detecting an abnormal print condition, and more particularly, to a print system capable of detecting an abnormal print condition according to a physical parameter variation rate.

2. Description of the Prior Art

In a normal inkjet printer, most of the ink jets are produced by piezoelectric materials and bubble materials. This means that the inkjets have a smaller volume and produce lower noises than a dot matrix printer. This also means, however, that the inkjets generate more heat. Today's technology often focuses on the heat generated by the inkjets. For example, a prior art temperature sensor feeds back detected temperature of the inkjets to the controller of the print system through an analog-to-digital converter (ADC). This can determine whether the temperature of the print system is higher than a normal temperature range and therefore if the whole print system is able to operate safely. If the temperature of the inkjets reaches the upper limitation of the operation temperature, the controlling end can send an immediate command to stop or slow down the operation of the print system. The quality of the ink drops is improved because the ink drops will not be affected due to excess temperatures. However, if a certain inkjet has too much current because the inkjet is short, the driving circuit of the inkjet becomes overheated because of the excess current. If only detected temperature of inkjets is used for determining whether the operation is stopped or slowed down then, even though the temperature of the inkjets has not reached the upper limitation, it is possible that the driving circuit of the inkjet will still be broken because of the current. Obviously, this situation cannot be detected. Furthermore, because today's technology focuses only on the heat generated by the inkjets, it ignores the heat generated by other devices (for example, the motor driving device and the power supplying device). Therefore, the whole print system may not operate as well as expected due to the heat. As mentioned above, not only heat generated by the inkjet but also heat generated by other devices should be considered. This can ensure the whole print system is of the highest quality.

### SUMMARY OF THE INVENTION

It is therefore one of the primary objectives of the claimed invention to provide a print system capable of detecting an abnormal printing condition according to a physical parameter variation rate, to solve the above-mentioned problem.

According to an exemplary embodiment of the claimed invention, a print system is disclosed. The print system comprises: a print module for printing an image; a motor driving module for driving the print module to print the image; a detecting module for detecting a physical parameter of a component of the print system; and a control module electrically connected to the detecting module for controlling an operation of the print system.

In addition, a method for controlling a print system is disclosed. The method comprises: detecting a first physical parameter and a second physical parameter of a component of the print system; utilizing the first physical parameter and the second physical parameter to generate a physical parameter variation rate; and adjusting an operation of the print system according to the physical parameter variation rate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a print system according to the present invention.

FIG. 2 is a flow chart of an operation of the print system shown in FIG. 1.

FIG. 3 is a block diagram of a detecting module according to the present invention.

FIG. 4 is a temperature curve of the print system in a normal condition.

FIG. 5 is a temperature curve of the print system in an abnormal condition.

FIG. 6 is a diagram of a normal temperature variation rate in each operational mode of the print system.

### DETAILED DESCRIPTION

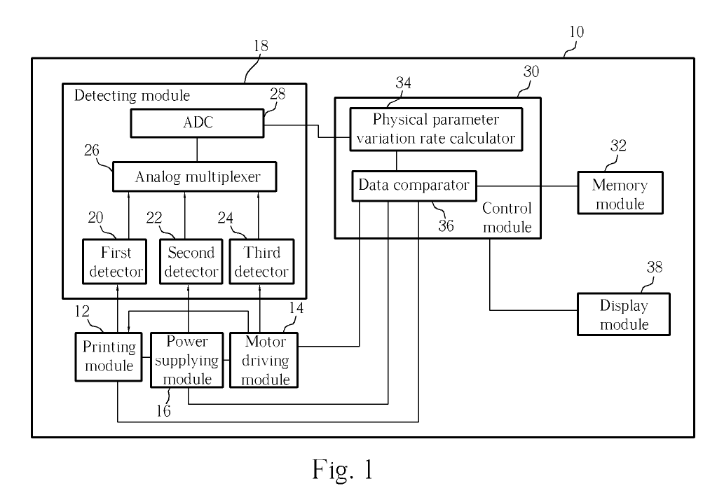

Please refer to FIG. 1, which is a block diagram of a print system 10 according to the present invention. The print system 10 comprises a printing module 12 for printing an image, a motor driving module 14 for driving the printing module 12 to print the image, and a power supplying module 16 for supplying needed power of an operation of the print system 10 and for supplying needed power of ink drops. This enables the printing module 12 to cooperate with the motor driving module 14 in order to spray the ink drops on corresponding media.

The print system 10 further comprises a detecting module 18 for detecting a physical parameter of a component of the print system 10. The detecting module 18 comprises a first detector 20, a second detector 22, and a third detector 24 for respectively detecting the physical parameters of the printing module 12, the power supplying module 16, and the motor driving module 14, where the physical parameters can be voltage, current, or temperature. Therefore, the above-mentioned detectors could be voltage detectors, current detectors, or temperature detectors. The detecting module 18 further comprises an analog multiplexer 26 for receiving the physical parameters detected by the first detector 20, the second detector 22, and the third detector 24, sampling the physical parameters, and selecting to output the physical parameters. In addition, the detecting module 18 further comprises an analog-to-digital converter (ADC) 28 for receiving the sampled physical parameters transferred from the analog multiplexer 26 and for transforming the sampled physical parameters into digital data. The print system 10 further comprises a control module 30 electrically connected to the detecting module 18 for controlling the print system 10. For example, the control module 30 can control the printing module 12 and the motor driving module 14 so that the printing module 12 can be driven by the motor driving module 14 to spray the ink drops on the corresponding media. Furthermore, the control module 30 can obtain a physical parameter variation rate according to the detected physical parameters of the detecting module 18 and can adjust the operation of the print system 10 according to the physical parameter variation rate. The print system 10 further comprises a memory module 32 for storing a normal physical parameter variation rate. The control module 30 comprises a physical parameter variation rate calculator 34 for receiving data transferred from the ADC 28 and performing a calculation on detected physical parameters of the detecting module 18 to generate the physical parameter variation rate, and a data comparator 36 for comparing the physical parameter variation rate generated by the physical parameter variation rate calculator 34 with the normal physical parameter variation rate stored in the memory module 32. Here, the control module 30 can adjust the operation of the print system 10 according to the comparison result. The print system 10 further comprises a display module 38 for displaying the operation of the print system 10.

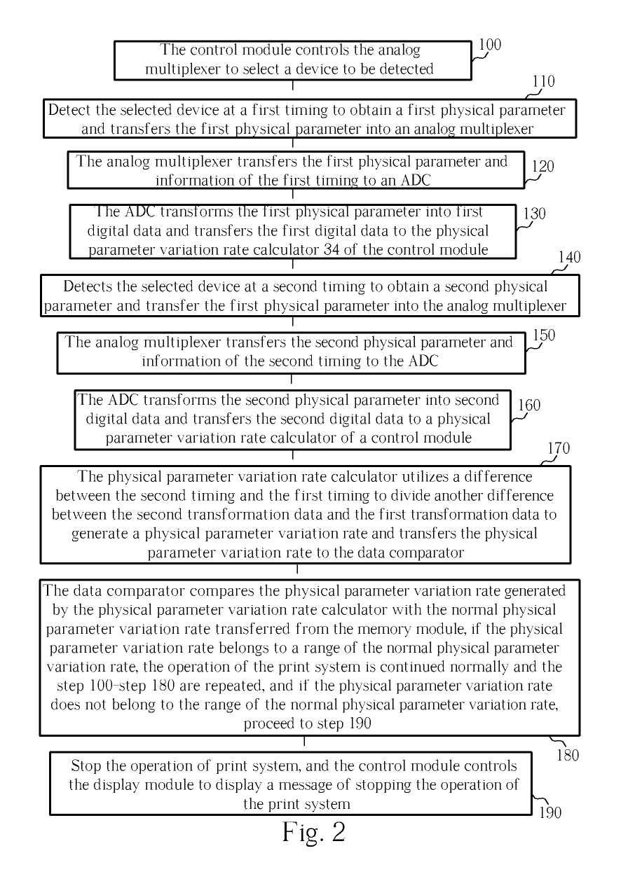

Please refer to FIG. 2, which is a flow chart of the operation of the print system 10 shown in FIG. 1. The flow chart comprises the following steps:

Step 100: The control module 30 controls the analog multiplexer 26 to select either the printing module 12 or the power supplying module 16 or the motor driving module 14 to be detected;

Step 110: One of the detectors corresponding to the selected device in step 100 (i.e. either the first detector 20 or the second detector 22 or the third detector 24) detects the selected device at a first timing to obtain a first physical parameter and transfers the first physical parameter into the analog multiplexer 26;

Step 120: The analog multiplexer 26 transfers the first physical parameter and information of the first timing to the ADC 28;

Step 130: The ADC 28 transforms the first physical parameter into a first digital data and transfers the first digital data to the physical parameter variation rate calculator 34 of the control module 30;

Step 140: The detector corresponding to the selected device in step 100 detects the selected device at a second timing to obtain a second physical parameter and transfers the first physical parameter into the analog multiplexer 26;

Step 150: The analog multiplexer 26 transfers the second physical parameter and information of the second timing to the ADC 28;

Step 160: The ADC 28 transforms the second physical parameter into a second digital data and transfers the second digital data to the physical parameter variation rate calculator 34 of the control module 30;

Step 170: The physical parameter variation rate calculator 34 utilizes a difference between the second timing and the first timing to divide another difference between the second transformation data and the first transformation data to generate a physical parameter variation rate and transfers the physical parameter variation rate to the data comparator 36;

Step 180: The data comparator 36 compares the physical parameter variation rate generated by the physical parameter variation rate 34 with the normal physical parameter variation rate transferred from the memory module 32; if the physical parameter variation rate belongs to a range of the normal physical parameter variation rate, the operation of the print system 10 is continued normally and the steps 100-180 are repeated, and if the physical parameter variation rate does not belong to a range of the normal physical parameter variation rate, proceed to step 190;

Step 190: The operation of print system 10 is stopped, and the control module 30 controls the display module 38 to display a message of stopping the operation of the print system 10.

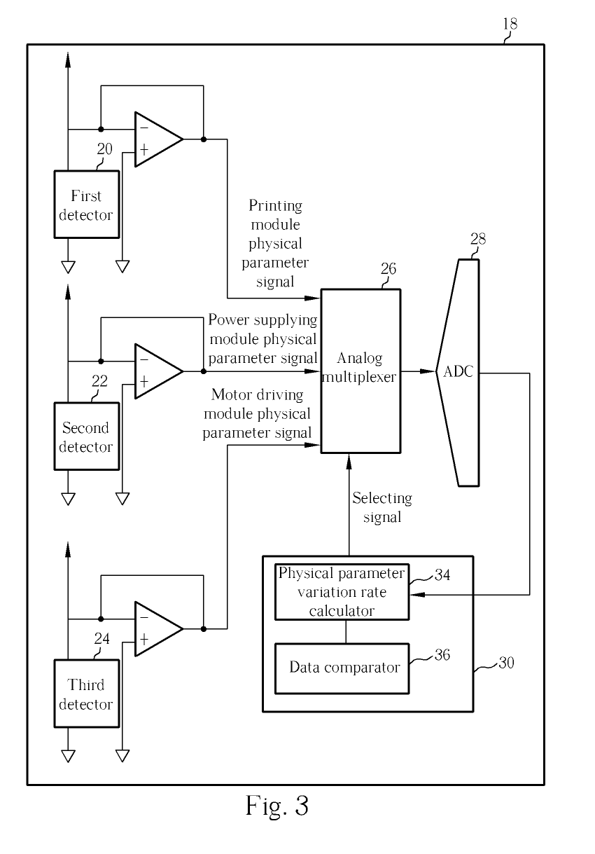

Here, we continue to discuss the operation of the print system 10. Please refer to FIG. 3, which is a block diagram of a detecting module 18 according to the present invention. The analog multiplexer 26 can simultaneously receive the physical parameters, which are detected by the first, second, and third detectors 20, 22, and 24 respectively, generated by the printing module 12, the power supplying module 16, and the motor driving module 14. In this embodiment, physical parameter signals can be amplified by an amplifier and then transferred into the analog multiplexer 26. On the other hand, the analog multiplexer 26 can receive a selecting signal transferred from the control module 30 and output one of the physical parameter signals of the first detector 20, the second detector 22, and the third detector 24 to the ADC 28 according to the selecting signal. In other words, the signal from a selected device is transferred to the ADC 28 for undergoing physical parameter variation rate calculation. For example, if the physical parameter variation rate of the printing module 12 has to be calculated, the control module 30 outputs a selecting signal to the analog multiplexer 26 to select the printing module 12. The analog multiplexer 26 then outputs the first physical parameter, which is received by the first detector 20 at the first timing, and the second physical parameter, which is received by the first detector 20 at the second timing, to the ADC 28. Please note that the time interval between the first timing and the second timing can be determined by design demands, i.e. the sampling time interval of the physical parameters can be determined by demands. Furthermore, if multiple physical parameter variation rates have to be obtained, a series of physical parameter signals can be outputted to the ADC 28 under a limitation of a specific time interval in order to calculate the needed multiple physical parameter variation rates. In addition, the analog multiplexer 26 can not only select one of the three physical parameter signals to be outputted to the ADC 28, but can also transfer two or all three physical parameter signals to the ADC 28. This depends on the devices needed to calculate the physical parameter variation rate. In this embodiment, the printing module 12, the power supplying module 16, and the motor driving module 14 are utilized for an illustration, however other printing devices can have their physical parameters detected. Furthermore, the physical parameters can be temperatures, voltages, or currents.

The ADC 28 transforms the first physical parameter into the first digital data, transforms the second physical parameter into the second digital data, and transfers the first digital data and the second digital data to the physical parameter variation rate calculator 34 of the control module 30 for undergoing calculation. The physical parameter variation rate calculator 34 utilizes the difference between the second timing and the first timing to divide the difference between the second transformation data and the first transformation data in order to generate a physical parameter variation rate. The equation is illustrated as follows:
Physical parameter variation rate=(Second digital data−First digital data)/(Second timing−First timing)

The physical parameter variation rate calculator 34 then transfers the physical parameter variation rate to the data comparator 36, which then compares the physical parameter variation rate with the normal physical parameter variation rate. If the physical parameter variation rate lies between an upper limitation and a lower limitation of the normal physical parameter variation rate, this represents that the physical parameter variation rate belongs to a range of the normal physical parameter variation rate. Therefore, the control module 30 controls the printing system 10 to continue the operation of the print system 10 normally. On the other hand, if the physical parameter variation rate is higher than the upper limitation of the normal physical parameter variation rate or below the lower limitation of the normal physical parameter variation rate, the control module 30 stops the operation of the print system 10 and controls the display module 38 to display a message of stopping the operation of the print system 10.

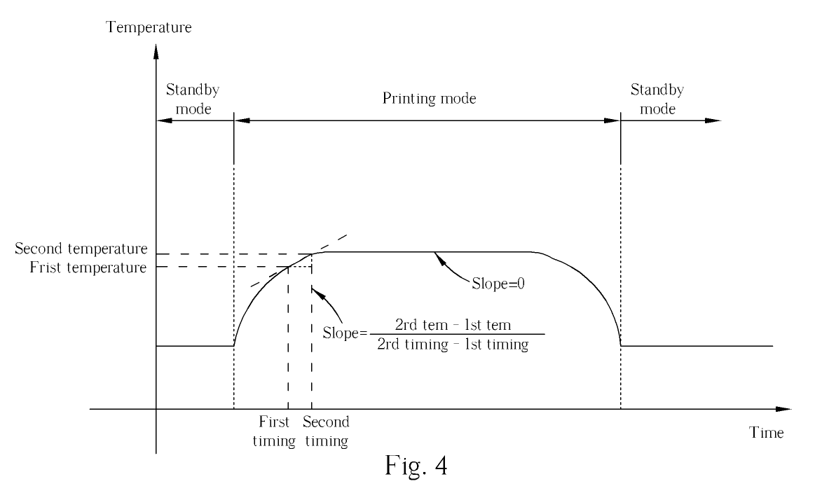

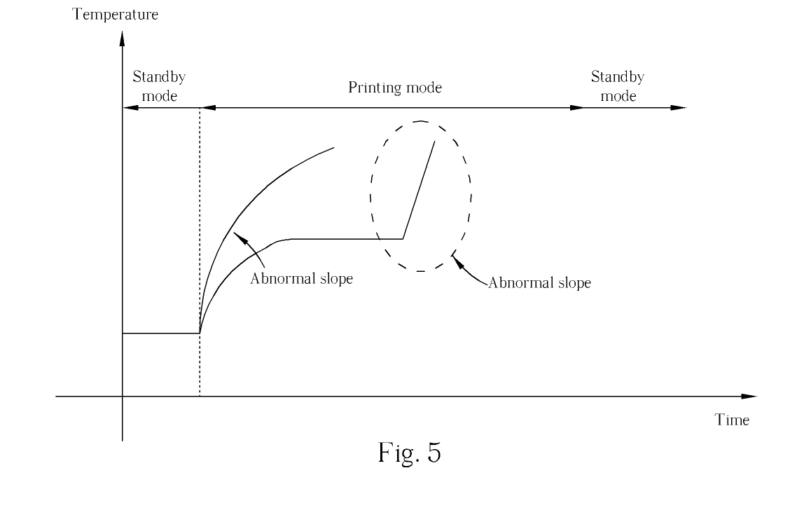

Please refer to FIG. 4 and FIG. 5. FIG. 4 is a temperature curve of the print system 10 in a normal condition. FIG. 5 is a temperature curve of the print system 10 in an abnormal condition. As shown in FIG. 4, when the print system 10 is in a normal condition and peripheral circuits are in a standby mode, the power consumption is at its lowest. The temperature variations of the peripheral circuits can therefore be maintained in a certain range substantially, (here, the temperature variation is shown as a slope in the figure). When the print system 10 is in the printing mode, the temperature of the peripheral circuits increases and is then maintained in a certain range. This is because the ink can only be ejected if the temperature is higher than a certain temperature. The temperature variation rate is theoretically in a normal range. Finally, once the print system 10 has completed the operation the print system comes back to the standby mode. The temperature of the print system 10 returns to the original temperature and the temperature variation rate is maintained. Please refer to FIG. 5. When the print system 10 is in an abnormal operation (for example, the device is short or broken), the peripheral devices may have abnormal temperature variation. At this time, the temperature variation rate may be over the normal range. As shown in FIG. 5, there are two abnormal temperature variation conditions. If the peripheral devices have an abnormal temperature variation rate, even though the current temperature is normal the device may still be broken. Any sudden rise of the temperature or the current is a sign that indicates the corresponding device may have shorted or broken. This holds true even if the current temperature or current is not high. Therefore, the present invention temperature variation rate can be utilized for preventing the above-mentioned situation. Furthermore, as shown in FIG. 4 and FIG. 5, temperature is detected for calculating the physical parameter variation rate. In addition, the voltage or current can also be utilized for calculating the physical parameter variation rate, and thus omitted here.

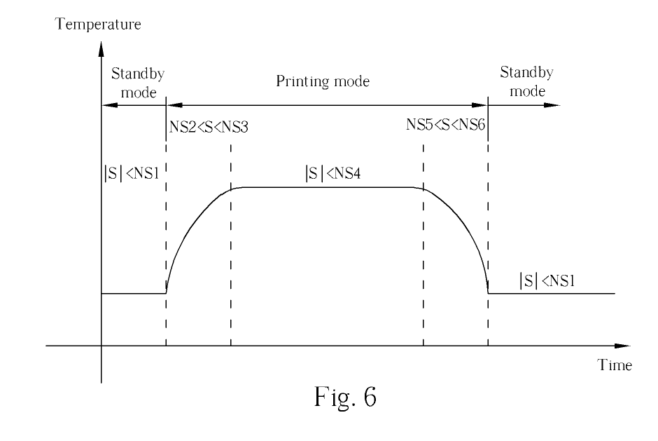

Please refer to FIG. 6, which is a diagram of a normal temperature variation rate in each operational mode of the print system 10. The corresponding normal temperature variation rates can be set in the memory module 32 according to different operation modes. As shown in FIG. 6, in the standby mode, the absolute value of the normal temperature variation rate is less than the value NS1. When the temperature rises in the printing mode, the normal temperature variation rate is between the values NS2 and NS3. When the temperature does not vary much in the printing mode, the absolute value of the normal temperature variation rate is less than the value NS4. When the temperature decreases in the printing mode, the normal temperature variation rate is between the values NS5 and NS6. Once the print system 10 has completed the printing operation and come back into the standby mode, the absolute value of the normal temperature variation rate is less than the value NS1. Please note that the setting of the normal temperature variation rates can be determined according to different operational modes, the detected devices, and the detected physical parameters.

Please note that in the present invention, the temperature variation rate can be ignored. That is, even when the temperature variation rate is not calculated, the present invention can still achieve the above-mentioned function. For example, the present invention can directly compare the physical parameters transferred from the first detector 20, the second detector 22, and the third detector 24 with normal (theoretical) physical parameters. The present invention can directly compare the first (or the second) physical parameter with the normal physical parameter. The present invention can then utilize the comparison result to adjust the operation of the print system 10.

In contrast to the prior art, the present invention print system can utilize the physical parameter variation rates of each device to ensure each device can operate in a stable operational range. In another situation, if the physical parameter variation rate of one of the devices is over the normal range, the control module reacts according to the above-mentioned situation to ensure that the whole function is not affected. Furthermore, the present invention removes the disadvantage of only detecting the temperature of devices of the print system in order to adjust the print system. The present invention can therefore prevent the devices from broken thereby extending the devices' lives and increasing the whole printing quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A print system comprising:
a print module for printing an image;
a motor driving module for driving the print module to print the image;
a detecting module for detecting a physical parameter of a component of the print system; and
a control module electrically connected to the detecting module for controlling an operation of the print system.

2. The print system of claim 1, wherein the detecting module is utilized for detecting the physical parameter of the print module.

3. The print system of claim 1, wherein the detecting module is utilized for detecting the physical parameter of the motor driving module.

4. The print system of claim 1 further comprising:
a power supplying module for supplying needed power for the operation of the print system;
wherein the detecting module is utilized for detecting the physical parameter of the power supplying module.

5. The print system of claim 4, wherein the detecting module comprises:
a plurality of sensors for measuring physical parameters of the print module, the motor driving module, and the power supplying module;
an analog multiplexer for receiving the physical parameters measured by the sensors, and sampling the physical parameters; and
an analog-to-digital converter for receiving the sampled physical parameters transferred from the analog multiplexer, transforming the sampled physical parameters into digital data, and transferring the digital data to the control module.

6. The print system of claim 5, wherein the sensor is a temperature sensor.

7. The print system of claim 1 further comprising:
a memory module for storing a normal physical parameter variation rate.

8. The print system of claim 7, wherein the control module adjusts the operation of the print system according to a comparison result between the physical parameter variation rate and the normal physical parameter variation rate.

9. The print system of claim 8, wherein the control module further comprises:
a physical parameter variation rate calculator for performing a calculation on physical parameters detected by the detecting module in a specific time interval to generate the physical parameter variation rate; and
a data comparator for comparing the physical parameter variation rate generated by the physical parameter variation rate calculator and the normal physical parameter variation rate stored in the memory module.

10. The print system of claim 1 further comprising:
a display module for displaying the operation of the print system.

11. The print system of claim 1, wherein the physical parameter is a temperature.

12. The print system of claim 1, wherein the physical parameter is a voltage.

13. The print system of claim 1, wherein the physical parameter is a current.

14. A method for controlling a print system comprising:
(a) detecting a first physical parameter and a second physical parameter of a component of the print system;
(b) utilizing the first physical parameter and the second physical parameter to generate a physical parameter variation rate; and
(c) adjusting an operation of the print system according to the physical parameter variation rate.

15. The method of claim 14, wherein the step (a) is detecting the first physical parameter at a first timing and detecting the second physical parameter at a second timing, and the step (b) is transforming the first physical parameter into a first transformation data, transforming the second physical parameter into a second transformation data, and utilizing a difference between the second timing and the first timing to divide another difference between the second transformation data and the first transformation data in order to generate the physical parameter variation rate.

16. The method of claim 14, wherein step (c) further comprises:
providing a normal physical parameter variation rate; and
adjusting the operation of the print system according to the comparison result between the physical parameter variation rate and the normal physical parameter variation rate.

17. The method of claim 16, wherein the step (c) further comprises:
if the physical parameter variation rate does not belong to a range of the normal physical parameter variation rate, stopping the operation of the print system.

18. The method of claim 17 further comprising:
displaying a message to show that the operation of the print system is stopped.

19. The method of claim 16, wherein the step (c) further comprises:
if the physical parameter variation rate belongs to a range of the normal physical parameter variation rate, continuing the operation of the print system.

20. The method of claim 14 further comprising:
selecting a component of the print system, wherein the component is utilized to calculate the physical parameter variation rate.

21. The method of claim 14 further comprising:
adjusting the operation of the print system according to the first physical parameter or the second physical parameter.

22. The method of claim 14, wherein the first physical parameter and the second physical parameter are both temperatures.

23. The method of claim 14, wherein the first physical parameter and the second physical parameter are both voltages.

24. The method of claim 14, wherein the first physical parameter and the second physical parameter are both currents.
